(19) United States
(12) Patent Application Publication
(10) Pub. No.: US 2003/0010118 A1
(43) Pub. Date: Jan. 16, 2003

(54) Apparatus for continuously measuring the liquid level in a container

(75) Inventor: Carsten Heldberg, Kichlinteln/Otersen (DE)

Correspondence Address: LOWE HAUPTMAN GOPSTEIN GILMAN & BERNER, LLP, Suite 310, 1700 Diagonal Road, Alexandria, VA, 22314, US

(73) Assignee: ITW Henschel GmbH

(21) Appl. No.: 10/193,226

(22) Filed: Jul. 12, 2002

(30) Foreign Application Priority Data
Jul. 14, 2001 (DE) 101 34 307.8

(51) Int. Cl. G01F 23/30

(52) U.S. Cl. 73/309

(57) ABSTRACT

Apparatus for measuring in continuous manner, i.e. detecting any arbitrary changes of the liquid level within a container, in particular regarding fuel in a motor-vehicle tank, comprising the following features:

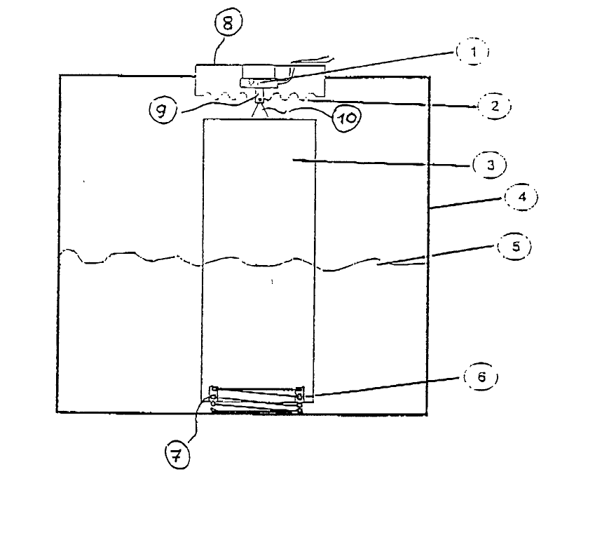

a buoyant body in the container,

a force detector affixed to a container wall,

a support at the opposite container wall, where

the buoyant body is mounted in substantially motionless manner while directed in the direction of buoyancy between the force detector and the support, and

an analyzer processing the signal from the force detector.

The present invention relates to apparatus which measures continuously, i.e. measuring any arbitrary changes of the liquid level in a container, in particular fuel in an automobile tank, as claimed in claim 1.

Numerous devices and procedures to measure the liquid level in a container are known. Illustratively the liquid level may be measured using a float of which the displacement shall be detected by appropriate accessories, for instance by a system of bars or rods, by capacitive, inductive or acoustic sensors or using optical devices. The said devices also may detect the liquid level in a container by determining the distance between said level and the device. Many procedures either are inaccurate or preclude continuous measurement.

The objective of the present invention is apparatus for continuously measuring the liquid level in a container, in particular fuel in a motor-vehicle tank, that shall be of especially simple design and may be operated in problem-free manner.

The solution to this problem is attained by the features of claim 1.

A buoyant body is configured in the liquid's container in the apparatus of the invention. Said buoyant body however shall not be displaced as the liquid level changes, instead it shall substantially keep its position, said position being predetermined by a support and a force detector that are situated on mutually opposite sides of the buoyant body. Accordingly the buoyant body shall be kept in place substantially without any displacement and it shall apply its buoyance substantially in the direction of the force detector. Accordingly, in the invention, the buoyancy is converted into a signal corresponding to the liquid level. The buoyance is proportional to the volume displaced by the body. If now the buoyant body is unable to move, or only little, and if this body exhibits an adequately linear volumetric increase in the direction of the top container side, then the buoyancy shall be directly proportional to the liquid level.

In order to also sense relatively low liquid levels, one embodiment of the present invention will compensate in part or in whole the intrinsic weight of the buoyant body by a spring mounted at the base. In this manner and using a corresponding spring, a small prestressing force may be applied to the force detector. Said force may be nulled in the analyzer following the force detector by shifting the zero point.

If the container cross-section is constant as the filling height changes, the buoyant body also shall preferably exhibit a constant cross-section over its length. If the container geometry varies with height, then the buoyant body shall be match said geometry in order to attain a signal which is proportional to the filled volume.

The force detector may be in the form of the most diverse methods and devices. Illustratively a piezoelectric-detector or strain gauges may be used. Also a force-dependent resistance is applicable, as well as a clamped oscillator of which the changes in frequency are detected as a function of the liquid level. Lastly the buoyancy of said buoyant body may be measured using capacitive and inductive methods.

The apparatus of the invention is especially applicable to electrically non-conducting liquids.

The invention is elucidated below in relation to an illustrative embodiment shown in the attached drawing.

The single FIGURE of the invention shows in very schematic manner an apparatus of the invention.

A liquid 5, for instance fuel, is held in a container 4 illustratively shown in the form of a box and denoting a motor-vehicle's tank. A hollow buoyant body 3 is received within the container 4 and in this embodiment exhibits constant cross-section over its length, for instance being a cylinder. The buoyant body 3 is fitted at its underside with an annular groove 7 entered by a spring 6. At its other end, the spring 6 rests against the bottom of the container 4.

A housing 8 is mounted in the ceiling wall of the container 4 and is sealed by a membrane 2 from the inside of the container 4. A pin 9 is mounted in the membrane and inside the housing 8 acts of a force detector 1 which illustratively may be a strain-gauge strip or a piezoelectric crystal. A contact element 10 at the portion of the pin which projects through the membrane 1 into the container 4 is linked to the top side of the buoyant body 3.

The force applied by the buoyant body 3 to the force detector 1 is proportional to the liquid level 5. The weight of the buoyant body 3 is compensated in part or in whole by the spring 6, a given bias on the force detector 1 being optional, but if used, then must be compensate in the omitted analyzer. The signal from the force detector 1 is fed to the omitted analyzer which, on an appropriate means, displays the liquid level or the volume of liquid in the container 4. Furthermore the value measured by the force detector 1 may be transmitted to a computer of the vehicle itself for instance to calculate the remaining mileage.

1. Apparatus for measuring in continuous manner, i.e. detecting any arbitrary changes of the liquid level within a container, in particular regarding fuel in a motor-vehicle tank, comprising the following features:
a buoyant body (3) in the container (4),
a force detector (1) affixed to a container wall,
a support (6) at the opposite container wall, where
the buoyant body (3) is mounted in substantially motionless manner while directed in the direction of buoyancy between the force detector (1) and the support (6), and
an analyzer processing the signal from the force detector (1).

2. Apparatus as claimed in claim 1, characterized in that the force detector (1) is mounted at the upper wall of the container (4) and the support (6) at its lower wall.

3. Apparatus as claimed in either of claims 1 and 2, characterized in that the buoyant body (3) is at least partly hollow.

4. Apparatus as claimed in one of claims 1 through 3, characterized in that the geometry of the buoyant body (3) matches the container inside space [so] that the buoyancy is approximately proportional to the liquid's volume.

5. Apparatus as claimed in one of claims 1 through 4, characterized in that a prestressing force in the direction of the force detector (1) is applied to the buoyant body (3).

6. Apparatus as claimed in claim 5, characterized in that the buoyant body (3) rests on a spring (6).

7. Apparatus as claimed in one of claims 1 through 6, characterized in that the force detector (1) is mounted in a housing (8) sealed by a membrane (2) from the inside space of the container, and in that the membrane is fitted with a pin (9) or the like which projects into the container (4) and which is connected to the buoyant body (3) and in that the pin (9) by its inner end acts on the force detector (1).
